(19) United States
(12) Patent Application Publication
(10) Pub. No.: US 2006/0233964 A1
(43) Pub. Date: Oct. 19, 2006

(54) Method of treating a wood element

(76) Inventor: Olivier Persenaire, (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/544,878

(22) PCT Filed: Feb. 11, 2004
(86) PCT No.: PCT/BE04/00019

§ 371 Date: Aug. 9, 2005

(30) Foreign Application Priority Data
Feb. 11, 2003 (EP) 03447024.5

(51) Int. Cl. B05D 1/18

(52) U.S. Cl. 427/440

(57) ABSTRACT

The invention relates to a method of treating an element made from wood, particularly end grain wood, comprising the following steps: immersion impregnation of the wood element in a bath containing an aqueous composition comprising at least one first component corresponding to a polyhydric alcohol and at least one second component corresponding to a blocked polyisocyanate which can react under certain conditions with the aforementioned first component in order to form a polyurethane, whereby the second component is non-reactive to the first component and is inert in relation to the water during the impregnation step; removal from the impregnation bath and dehydration of the wood element; and formation of a polyurethane network within the wood element thus impregnated by reacting the first component with the second component during a heat treatment process consisting in raising the temperature. The invention also relates to the bath and the impregnation composition used to carry out said method to the wood element thus obtained and to the use of same.

### SUBJECT OF THE INVENTION

The present invention relates to a method for treating a wooden element, preferably made of “end-grained” (standing) wood, i.e. wood cut in its natural direction of growth, i.e. transversely to the direction of the fibres.

### PRIOR ART

It is known to those skilled in the art that wood is sensitive to variations in humidity, which is reflected by dimensional instability, i.e. by swelling or, conversely, shrinkage of this wood.

As a result, various methods for treating wood have already been proposed in order to increase its dimensional stability. Among these methods, it has especially been suggested to impregnate wood with various polyurethanes. Examples that will be mentioned include documents U.S. Pat. No. 5,310,780, U.S. Pat. No. 6,191,213, JP 49 016 603, GB 1 372 840, U.S. Pat. No. 3,795,533 and WO 97/02134. The common feature of these methods is that they include several steps and that they use organic solvents. Depending on the case, the polyurethane is:
either preformed and not grafted to the cell walls of the wood;
or preformed and grafted;
or generated in situ, which also allows possible grafting.

Document DE 2 059 625 describes a method for forming a polyurethane foam obtained by immersing wood in an organic solution comprising the reagents required for the in situ formation of polyurethane and using the water contained in the wood for the reaction.

Unfortunately, many of these methods lead to filling of the lumen of the wood rather than to swelling of the cell walls, which, firstly, prevents high dimensional stabilization from being achieved, and, secondly, has a harmful effect on both the density and the appearance of the final material.

It has also been proposed to use polyalkylene glycols in the impregnation method, as is the case in the document by Danicher L. and Lambla M. (Revue du bois 3, 33 (1975)). This type of method combines the advantages of being easy to perform on an industrial scale and of giving the wood a high degree of stabilization. However, when the wood is placed under relative ambient humidity conditions close to saturation, the polyethylene glycols, which are highly hygroscopic compounds, have a tendency to diffuse out of the wood, which leads to swelling thereof. Moreover, and disadvantageously, this method requires the use of an organic solvent such as dichloromethane.

Belgian patent BE 799 494 describes a two-step treatment method. In a first step, polyethylene glycol oligomers are incorporated into the wood via an osmotic impregnation, and, in a second step, a polyurethane is formed by exposing the wood to diisocyanate vapours produced under reduced pressure, at a temperature above 90° C. This method has the drawback of being time-consuming and difficult to perform. In addition, this method results in inhomogeneous impregnation over the thickness of the wood, the formation of the polyurethane being largely favoured close to and at the surface. Finally, the use of diisocyanate in vapour form does not offer all the satisfactory guarantees in terms of safety and environmental friendliness.

Document DE 2 007 591 describes a method for impregnating wood with a thermosetting polyurethane solution comprising, in the form of microcapsules, an isocyanate acting as hardening agent, the impregnation being initiated by raising the temperature. A curing step is then performed by raising the temperature and the pressure so as to break the microcapsules and release the curing agent, which mixes with the thermosetting polyurethane within the pores of the wood.

### AIMS OF THE INVENTION

The present invention is directed towards providing a method for treating a wooden element that does not have the drawbacks of the prior art methods as have been described above.

In particular, the present invention is directed towards providing a method for obtaining an impregnated wood that has a high degree of dimensional stability.

The invention is also directed towards providing a method that is quick and simple to perform.

Another aim of the present invention is to provide a method of optimum environmental friendliness, especially by avoiding the use of organic solvents.

### DEFINITIONS

The term “wood” covers all species of hardwoods as well as softwoods, notably permeable and so-called “end-grained” woods.

This wood may especially be green wood or wood saturated with water.

The term “end-grained” wood should be understood as meaning sections of wood that have been cut up transversely to the direction of their fibres.

The term “wooden element” means any element made of wood, i.e. not only pieces of “raw” wood that have been cut up from a tree, but also wood that has undergone an industrial transformation such as parquet, panels or work surfaces (i.e. wood-based products).

The term “impregnation” means the action of making one or more substances penetrate into wood. In this case, the said substances are constituents of a so-called “impregnation composition”.

The term “network” means a three-dimensional structuring of polymer chains linked together either via covalent bonds, in which case it is referred to as a “chemical network” or a “crosslinked network”, or via weak bonds of “hydrogen bonding” type, in which case it is referred to as a “physical network”. The same network can be of both physical type and chemical type.

The polymer chains that form a network within the wood may be either exclusively exogenous polymer chains, or also endogenous polymer chains constituting the cell walls of the wood, such as the cellulose of the wood. In the latter case, when covalent bonds are formed between the exogenous polymer chains and the wood cellulose, the exogenous polymer is said to be “grafted” to the wood or to the wood cellulose. More generally, the notion of “grafting” assumes that the exogenous polymer has at least one active hydrogen capable of forming a covalent bond with at least one constituent molecule of the cell walls of the wood, such as cellulose.

In the present invention, the term “crosslinking” should thus be understood as meaning the action of covalently linking polymer chains together, in this case polyurethane chains, so as to form a network.

It should moreover be understood that the term “impregnation bath” denotes an aqueous bath whose composition is such that it contains both the polyol and the polyisocyanate that will directly impregnate the wood in a single step and that may then, under particular conditions of use, react in situ with each other within the wood to form the polyurethane and allow its polymerization, crosslinking and/or grafting within the wood.

The term “active hydrogen” is used to qualify a hydrogen belonging to a molecule and capable of reacting with a chemical group belonging to another molecule.

The terms “blocked” polyisocyanate and “protected” polyisocyanate mean a polyisocyanate whose isocyanate functions have been protected with a so-called “blocking agent” so as to render them inert with respect to active hydrogens. This blocking or this protection is reversible. This is then referred to as “deblocking” or “deprotection” of the isocyanate functions.

In general, reference will be made to the chapter on polyurethanes written by Daniel HATAT (Techniques de l'ingénieur No. A 3425 Volume AM 2) for the chemical terminology used herein.

### SUMMARY OF THE INVENTION

The present invention relates to a method for treating a wooden element, in particular made of “end-grained” wood, comprising the following steps:
impregnation by immersion of the said wooden element in a bath containing an aqueous composition comprising at least a first constituent corresponding to a polyol and at least a second constituent corresponding to a blocked (or protected) polyisocyanate capable of reacting under certain conditions with the said first constituent to form a polyurethane, the second constituent being unreactive towards the said first constituent and inert towards water in this impregnation step;
removal from the impregnation bath and dehydration of the said wooden element;
formation of a polyurethane network within the wooden element thus impregnated by reacting the said first constituent with the said second constituent by means of a rise in temperature.

Advantageously, according to the invention, the wood of the wooden element is in green or water-saturated form.

Preferably, the first constituent of the impregnation composition is a water-soluble polyol comprising one or more active hydrogens and selected from the group consisting of mono-ol and polyol polyethers, mono-ol and polyol polyacrylics, mono-ol and polyol polyvinyls, polysaccharides, derivatives thereof in which at least one hydroxyl function is substituted with a thiol or amine function, and also mixtures and copolymers thereof.

Advantageously, the first constituent of the impregnation composition is an oligomer with a molecular weight of between 100 and 5000 and preferably between 200 and 1000.

Preferably, the said second constituent of the impregnation composition is a polyisocyanate selected from the group consisting of polyisocyanates, derivatives thereof and mixtures thereof, the isocyanate functions of the said second constituent being protected so as to render them inert towards water and towards the first constituent in the impregnation step, and capable of being deprotected by means of a suitable treatment.

Advantageously, the said second constituent is a diisocyanate whose isocyanate functions are protected, preferably carbonylbis(caprolactam) or CBC.

Preferably, in the method of the present invention, each of the first and second constituents is present in the aqueous impregnation composition in a concentration of between 10⁻³ and 5 mol.l⁻¹ and preferably between 0.1 and 1 mol.l⁻¹.

Preferably, the impregnation step is performed at a temperature of between 0° C. and 100° C. and preferably between 20° C. and 60° C.

Advantageously, the impregnation step is performed at room temperature.

Preferably, the duration of the heat treatment step is between 10 minutes and 72 hours and preferably between 1 and 24 hours.

Preferably, the impregnation step is performed at a pressure generally of between 10⁻³ and 10² bar and preferably between 0.1 and 10 bar.

Advantageously, the impregnation step is performed at atmospheric pressure.

Preferably, in the method of the invention, the said heat treatment is performed at a temperature of between 50° C. and 250° C. and preferably between 100° C. and 150° C., and the duration of which is predetermined.

Preferably, the duration of the heat treatment step is between 5 minutes and 5 hours and preferably between 15 minutes and 120 minutes.

Preferably, the said treatment is performed at a pressure generally of between 10⁻³ and 10² bar and preferably between 0.1 and 10 bar.

Preferably, the dehydration of the wooden element is performed by heating or by depressurization.

The present invention also relates to a wooden element obtained by means of the method of the invention as described above.

Another subject of the invention relates to an impregnation bath comprising an impregnation composition for performing the method according to the invention, the present invention also relating to the said composition itself.

Preferably, this composition is an aqueous solution comprising at least a first constituent corresponding to a polyol and at least a second constituent corresponding to a polyisocyanate whose isocyanate functions are protected so as to render the said polyisocyanate inert towards water and towards the alcohol function(s) of the said first constituent at room temperature, the said isocyanate functions being capable, under particular conditions of use, of being deprotected and thus of reacting with the alcohol function(s) of the said first constituent to form a polyurethane.

Finally, the present invention also relates to the use of the method and/or of the wooden element and/or of the impregnation bath according to the invention in the field of coverings, such as wall and/or floor coverings, parquets, work surfaces, panels and furniture.

### BRIEF DESCRIPTION OF THE FIGURES

FIG. 1 is an SEM microphotograph of a transverse cross section of wood impregnated with polyethylene glycol (PEG) after Soxhlet extraction according to Example 1.

FIG. 2 is an SEM microphotograph of a transverse cross section of wood sequentially impregnated so as to form polyurethane in situ according to Example 2.

FIG. 3 is an SEM microphotograph of a transverse cross section of treated wood, obtained by “one-pot” impregnation according to the method of the invention so as to form polyurethane in situ according to Example 3.

### DETAILED DESCRIPTION OF THE INVENTION

The characteristic feature of the method of the invention is thus that the impregnation of the wood to subsequently form a polyurethane network in the wood is performed in a single step and in aqueous phase. The constituents of the impregnation composition used to impregnate the wood, i.e. both the polyol and the blocked polyisocyanate, are compounds that are water-soluble or dispersible in aqueous phase, the said polyisocyanate being reactive towards the polyol under certain conditions of use.

In other words, the method according to the present invention corresponds to a “one-pot” impregnation method.

This “one-pot” impregnation leads to result that are entirely surprising and unexpected at least in terms of the dimensional stability of the wood and possibly of the mechanical properties of the wood, which are partly explained by a synergistic effect between the water, the polyol and the polyisocyanate, since these results are not found when the wood is sequentially impregnated with polyol and polyisocyanate (see the examples below).

It will be noted that the impregnation bath may also comprise a catalyst such as those used in the prior art. For example, tin (IV)-based derivatives or derivatives of tertiary amine type may also be incorporated into the bath, as may Lewis acids such as MgBr₂.

The constituents included in the impregnation bath may be used in variable molar ratios that a person skilled in the art can readily determine so as to adjust the molar ratio of the reactive functions.

In general, it has been observed that the porosity and, consequently, the density of the wood have a strong influence on the experimental conditions to be used.

In addition, advantageously, the concentration of the polyisocyanate in the impregnation bath is such that the molar ratio of the isocyanate functions and of the functions containing an active hydrogen ranges between 0.1 and 15 and preferably between 1 and 5.

It will be noted that the impregnation and crosslinking may take place with stirring, for example with mechanical stirring.

The heat treatment to which the impregnated wood is subjected after the impregnation step allows the deprotection and/or activation of the isocyanate functions of the polyisocyanate (“deblocking”) and gives rise to the formation of a crosslinked polyurethane within the wood, via allophanate or biuret bonds.

After performing the method according to the invention, an interpenetrated network is thus formed within the wooden element between the polyurethane chains and the constituent polymers of the cell walls of the wood, which may involve covalent grafting reactions depending on the initial isocyanate/alcohol stoichiometry. By virtue of the constitution of this network, the treatment method according to the invention makes it possible, entirely surprisingly, to improve the dimensional stability of the wood (and thus of the wooden element), without affecting its mechanical properties or its appearance, which is particularly advantageous. The mechanical properties of the wooden element may even be improved under certain conditions.

Furthermore, it has been observed that the method according to the invention induces only swelling of the cell walls of the wood, without filling the lumen with polyurethane. As a result, it is possible to maintain the density of the impregnated wood at a relatively low value and relatively close to the density of the wood under ambient humidity conditions.

According to the invention, it may then be contemplated to apply a covering to the surface of the wooden element impregnated in the manner described above. This covering, applied according to the well-known techniques of the prior art, may be either a varnish (polyurethane or the like) or a paint.

### IMPLEMENTATION EXAMPLES

It will be noted that, in these examples, the dimensional stability of untreated and treated poplar samples was measured by subjecting these samples to two “wetting-drying” cycles.

More specifically, the samples were either subjected in a chamber to a humid atmosphere with a constant humidity level (90%) or immersed in a bath of running water (25° C.) for a given time, twice. Each cycle lasts for 41 hours. In order to accurately characterize the dimensional stability improvement generated by the reactive impregnation treatment in liquid phase, it is the anti-swelling efficiency, ASE, that was determined for each cycle, according to the recommendations found in the scientific literature (Dimensional stabilization of wood in use, Research Note FPL-0243, Forest Products Laboratory, United States Department of Agriculture, Madison (Wis.), 1981). There is thus for each cycle a corresponding value ASE₁ (first cycle) or ASE₂ (second cycle).

The anti-swelling efficiency (or ASE) was calculated in the manner described below.

First, the swelling coefficient is determined by means of equation 1.

$$S = \frac{{V}_{2} - {V}_{1}}{{V}_{1}} \qquad Equation 1$$

in which
S=volumetric swelling coefficient
V₂=volume of the sample of wood after wetting
V₁=volume of the sample of dried wood before wetting

It is then possible to calculate the ASE value by means of equation 2.

$$ASE = \vert \frac{{S}_{2} - {S}_{1}}{{S}_{1}} \vert \qquad Equation 2$$

in which
ASE=anti-swelling efficiency resulting from the treatment of the wood
S₂=volumetric swelling coefficient of the treated wood
S₁=volumetric swelling coefficient of the untreated wood.

### COMPARATIVE EXAMPLES

### Example 1

### Impregnation with PEG

A sample A of poplar (Populus spp.) of 60×60×10 mm³ (radial×tangential×longitudinal) was impregnated with polyethylene glycol (PEG) 400 by immersion in an aqueous solution thereof with a concentration of 0.75 mol.L⁻¹. After an impregnation time of 24 hours, the weight fraction of PEG was 57.8% and the mass per unit volume of the sample of wood was 0.48 g.cm⁻³.

After Soxhlet extraction with water for 48 hours, the total amount of PEG incorporated was extracted, which confirms the need to use a polyisocyanate to form polyurethane chains that are crosslinked and chemically grafted to the cell walls of the wood and also an interpenetrated network between these same chains and the constituent polymers of the cell walls.

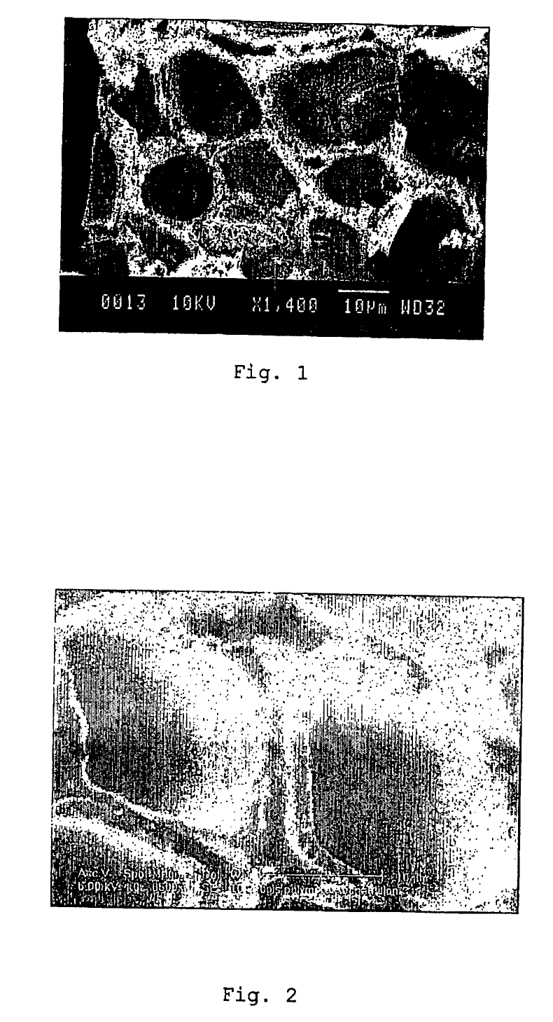

FIG. 1 is an SEM microphotograph of this sample. As seen in this figure, the cell walls of the wood are not swollen. Their thickness is in fact identical to that of the cell walls of the untreated wood, i.e. about 1.5 μm.

### Example 2

### Sequential Impregnation Using CBC as Protected Polyisocyanate

A sample N of poplar (Populus spp.) of 60×60×10 mm³ (radial×tangential×longitudinal) was impregnated, in an autoclave, with PEG 400 by immersion in an aqueous solution (0.5 mol.L⁻¹) thereof for 2 hours 30 minutes at a pressure of 6 bar. After this time, this sample was impregnated in an autoclave with a protected diisocyanate, carbonylbis(caprolactam) or CBC (see formula below) by immersion in an aqueous dispersion thereof (12.6 wt % of CBC) for 2 hours 30 minutes at a pressure of 6 bar. The sample was then dried at 70° C. under vacuum for 1 hour 30 minutes and a heat treatment at 150° C. (under vacuum) was performed. 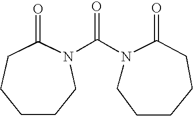
formula of carbonylbis(caprolactam) or CBC

The weight fraction of polyurethane obtained was 39.2%. The loss of mass after Soxhlet extraction was greater than 99%.

These results bear evidence of the need to perform the impregnations with the polyol, and with CBC simultaneously, i.e. using the same impregnation bath, in order to ensure adequate incorporation of the polyurethane into the wood and also its grafting and crosslinking.

FIG. 2 corresponds to an SEM microphotograph of the sample thus treated. Compared with a microphotograph of a sample of wood impregnated with only PEG as shown in FIG. 1 (see Example 1), FIG. 2 confirms that the treated wood has not been homogeneously impregnated and that the formation of a polyurethane network therein is not extensive. Very little swelling of the cell walls of the wood is seen therein, the measured thickness of the walls being only of about 1.8 μm.

### EXAMPLES OF “ONE-POT” IMPREGNATION ACCORDING TO THE INVENTION

### Examples 3 to 7

### Use of carbonylbis(caprolactam) (CBC) as Protected Isocyanate

### Example 3

### Dimensional Stability Tests

A sample L of poplar (Populus spp.) of 60×60×10 mm³ (radial×tangential×longitudinal) was impregnated with PEG 400 functionalized with carbonylbis(caprolactam) (CBC). To do this, the PEG oligomers (20 g), dehydrated beforehand, are reacted with 25.20 g of CBC under nitrogen and the reaction is performed at 150° C. for 1 hour 30 minutes. The principle of this reaction is as follows:

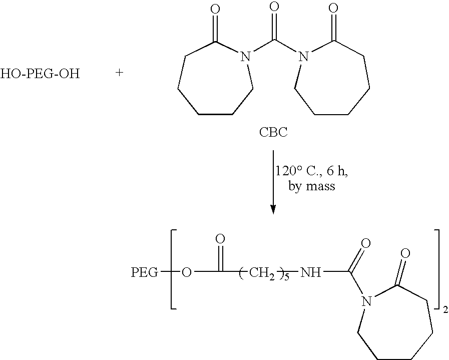

The PEG oligomers thus functionalized were dispersed in 200 ml of a PEG 400 solution so as to obtain a total PEG concentration of 0.5 mol.L⁻¹. This mixture was then introduced into a stainless-steel autoclave (volume: 1.2 L) containing the sample of wood. The impregnation was then performed at room temperature at a pressure of 6 bar for 2 hours 30 minutes. After this time, the wood was dehydrated at 70° C. under vacuum for 1 hour 30 minutes, and a heat treatment was performed for 16 hours at 150° C. The weight fraction of polyurethane obtained was 110.7%.

The ASE and the loss of mass after Soxhlet extraction are collated in Table 1.

TABLE 1
Dimensional stability, Soxhlet extraction
tests and mass per unit volume

| | (a) | (b) | (c) | (d) | (e) |
|---|---|---|---|---|---|
| Sample | Test | ASE₁(%) | ASE₂(%) | Δm(%) | ρ(g · cm⁻³) |
| L | humidity | 63 ± 11 | 69 ± 6 | 28 | 0.6 |
| | immersion | 82 ± 8 | 38 ± 2 | | |

(a) sample placed in a chamber under a humid atmosphere at a constant humidity level (90%) (“humidity”) or immersed in a bath of running water (25° C.) for a given time (“immersion”)
(b) anti-swelling efficiency after the first “wetting-drying” cycle
(c) anti-swelling efficiency after the second “wetting-drying” cycle
(d) loss of mass of polyurethane PU (=mass of PU extracted/initial mass of PU)
(e) density

As shown by the results of Table 1, the wood after a treatment according to the invention shows increased dimensional stability. It will be noted that the ASE values obtained here for a wood treated according to the method of the invention range between about 40% and about 85% and are comparable with those generally reported in the prior art for other impregnation methods. The ASE value is indeed about 38% in the case of an impregnation using perfluoroalkyl chains (Engonga P. E. et al. (2000), J. Fluor. Chem. 101, 19) and does not exceed 70% after impregnation of the wood with epoxides or isocyanates (Rowell R. M. & Ellis W. D. (1979), Wood Sci. 12, 52).

The use of CBC thus gives very good results in terms of dimensional stability of the wood.

Furthermore, these results compared with those obtained in Example 2, in which the sample of wood was impregnated with PEG and polyisocyanate blocked with CBC not simultaneously as herein but sequentially, suggest, entirely unexpectedly, that there is a synergistic effect between the water, the polyol and the polyisocyanate to form a polyurethane network within the wood.

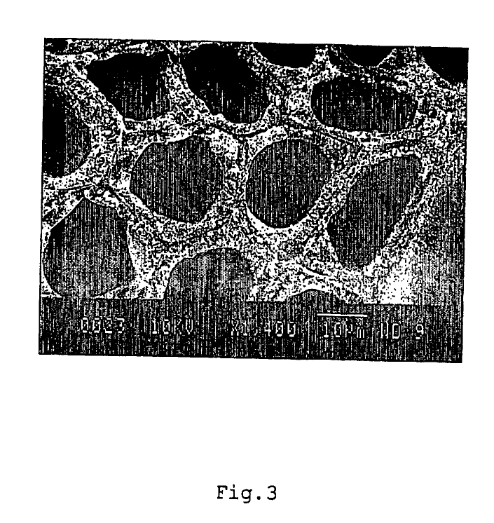

A microphotograph (obtained by scanning electron microscopy) of a transverse cross section of wood thus impregnated is shown in FIG. 3. No filling of the lumen can be observed, but substantial swelling of the cell walls of the wood is seen, this swelling being expected in order to lead to the improvement in the dimensional stability of the wood. The cell walls reach, in this case, a thickness of about 2.5 μm. This swelling is moreover expected to be accompanied by an improvement in the mechanical properties of the wood, which will be confirmed during the bending and compression tests performed in Example 5.

In addition, these observations confirm the formation of an interpenetrated network within the very cell walls of the wood without filling of the lumen, this taking place directly by “one-pot” impregnation in aqueous phase. Moreover, it should be noted that this impregnation takes place homogeneously throughout the thickness of the sample, which is an important characteristic of the present invention.

For comparison, reference will be made to FIG. 2, which showed, as described above, the SEM microphotograph of a transverse cross section of the sample of wood taken in Example 2 and which demonstrated very low swelling of the cell walls of the wood.

### Example 4

### Other Dimensional Stability Tests

A sample M of poplar (Populus spp.) of 60×60×10 mm³ (radial×tangential×longitudinal) was impregnated with PEG 400 functionalized with carbonylbis(caprolactam) (CBC). To do this, the dried PEG oligomers (20 g) are reacted with 25.20 g of CBC under nitrogen and the reaction is conducted at 150° C. for 1 hour 30 minutes.

The functionalized PEG oligomers were dispersed in 200 ml of a PEG 400 solution in order to obtain a total PEG concentration of 0.5 mol.L⁻¹. This mixture was then introduced into an autoclave containing the sample of wood. The impregnation was then performed at room temperature under a pressure of 6 bar for 2 hours 30 minutes. After this period, the wood was dehydrated at 70° C. under vacuum for 1 hour 30 minutes and a heat treatment was performed for 1 hour 30 minutes at 150° C. The weight fraction of polyurethane obtained was 132.4%.

As for sample L (Example 3), sample M shows high dimensional stability, as shown in Table 2. These results confirm that carbonylbis(caprolactam) is an excellent candidate as a protected polyisocyanate in the method according to the invention.

TABLE 2
Dimensional stability, Soxhlet extraction
tests and mass per unit volume

| | (a) | (b) | (c) | (d) | (e) |
|---|---|---|---|---|---|
| Sample | Test | ASE₁(%) | ASE₂(%) | Δm(%) | ρ(g · cm⁻³) |
| M | humidity | 62 ± 15 | 82 ± 22 | 59 | 0.6 |
| | immersion | 69 ± 22 | 46 ± 5 | | |

### Example 5

### Evaluation of the Mechanical Properties

The mechanical properties of samples of impregnated wood having different weight fractions of polyurethane were evaluated by means of bending tests (parallel to the fibres) and compression tests (perpendicular to the fibres). The results obtained for these composites are compared with those obtained for untreated poplar.

The bending tests were performed on four samples of 54×10×10 mm³ (axial×radial×tangential) preconditioned at a humidity level of 40% and a temperature of 20° C. for 24 hours. The results are given in Table 3.

As may be seen, and in contrast with many other chemical modifications, impregnation with polyurethane does not impair the mechanical properties of the wood.

TABLE 3
Bending tests

| | (h) | Young's modulus | Bending at |
|---|---|---|---|
| Sample | FW_{PU}(%) | (MPa)⁽ⁱ⁾ | break (%) |
| Untreated poplar | 0 | 98 ± 9 | 15 ± 3 |
| C6 | 113 | 110 ± 15 | 14 ± 1 |
| C7 | 89 | 96 ± 11 | 14 ± 1 |

⁽ⁱ⁾defined as being the largest slope of the “Stress-Deflection” curve
(h) weight fraction of polyurethane

Compression tests were performed on four samples of 10×18×10 mm³ (axial×radial×tangential) conditioned at a humidity level of 40% and a temperature of 20° C. for 24 hours. The stress is applied perpendicular to the fibres and parallel to the tangential direction. The results obtained are given in Table 4.

The results confirm that the impregnation with polyurethane does not impair the mechanical properties of the wood, a slight increase in the Young's modulus even being observed in the case of the composite C7.

TABLE 4
Compression tests

| | | (j) |
|---|---|---|
| | (h) | Young's modulus |
| Sample | FW_{PU}(%) | (MPa)^{(a)} |
| Untreated poplar | 0 | 79 ± 7 |
| C6 | 113 | 109 ± 23 |
| C7 | 90 | 116 ± 7 |

(j) defined as being the largest slope of the “Stress-Deformation” curve
(h) weight fraction of polyurethane

### Example 6

### Other Tests

A sample N of poplar (Populus spp.) of 60×60×10 mm³ (radial×tangential×longitudinal) was impregnated with PEG 1000 functionalized with carbonylbis(caprolactam) (CBC). To do this, the dried PEG oligomers (100 g) are reacted with 50.40 g of CBC under nitrogen and the reaction is performed at 150° C. for 1 hour 30 minutes in the presence of MgBr₂ (0.75 mol % relative to the CBC).

The functionalized PEG oligomers were dispersed in 200 ml of a solution of PEG 1000 in order to obtain a total PEG concentration of 0.5 mol.L⁻¹. This mixture was then introduced into an autoclave containing the sample of wood. Impregnation was then performed at room temperature under a pressure of 6 bar for 2 hours 30 minutes. After this period, the wood was dehydrated at 70° C. under vacuum for 1 hour 30 minutes and a heat treatment was performed for 1 hour 30 minutes at 150° C. The weight fraction of polyurethane obtained was 88.3%. As reported in Table 10, the sample obtained shows high dimensional stability.

TABLE 5
Dimensional stability, Soxhlet extraction
tests and mass per unit volume

| Sample | Test | ASE₁(%) | ASE₂(%) | Δm(%) | ρ(g · cm⁻³) |
|---|---|---|---|---|---|
| N | humidity | 63 ± 5 | 57 ± 9 | 90 | 0.5 |
| | immersion | 69 ± 6 | 38 ± 2 | | |

### Example 7

### Other Tests

A sample O of poplar (Populus spp.) of 60×60×10 mm³ (radial×tangential×longitudinal) was impregnated with PEG 1000 functionalized with carbonylbis(caprolactam) (CBC). To do this, the dried PEG oligomers (100 g) are reacted with 50.40 g of CBC under nitrogen and the reaction is performed at 150° C. for 1 hour 30 minutes in the presence of MgBr₂ (0.75 mol % relative to the CBC).

The functionalized PEG oligomers were dispersed in 200 ml of a solution of PEG 1000 in order to obtain a total PEG concentration of 0.5 mol.L⁻¹. The sample of wood was immersed in this mixture. Impregnation was then performed at room temperature and atmospheric pressure for 2 hours 30 minutes. After this period, the wood was dehydrated at 70° C. under vacuum for 1 hour 30 minutes and a heat treatment was performed for 1 hour 30 minutes at 150° C. The weight fraction of polyurethane obtained was 73.3%. As reported in Table 11, the sample obtained shows high dimensional stability.

TABLE 6
Dimensional stability, Soxhlet extraction
tests and mass per unit volume

| Sample | Test | ASE₁(%) | ASE₂(%) | Δm(%) | ρ(g · cm⁻³) |
|---|---|---|---|---|---|
| O | humidity | 57 ± 19 | 63 ± 12 | 59 | 0.4 |
| | immersion | 53 ± 8.0 | 36 ± 1 | | |

### Examples 8 and 9

### Use of Other Protected Polyisocyanates

### Example 8

### Use of Rhodocoat® as Protected Polyisocyanate

Two samples G and H of poplar (Populus spp.) of 60×60×10 mm³ (radial×tangential×longitudinal) were simultaneously impregnated with PEG 400 and the following protected triisocyanurate:

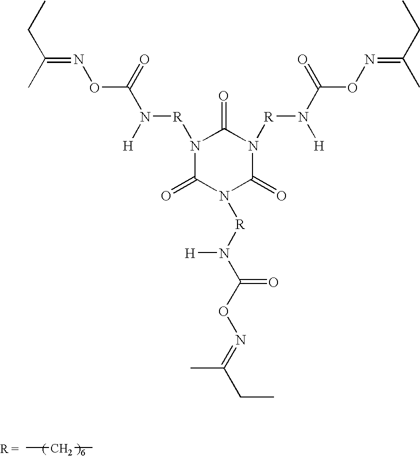

This reagent is sold by Rhodia S. A. under the trade name Rhodocoat® WT1000. To do this, these samples were immersed in an aqueous solution of PEG 400 in which the triisocyanurate was dispersed. This mixture was thermostatically maintained either at room temperature (G) or at 50° C. (H) . The amounts of reagents were adjusted such that the molar ratio of the hydroxyl functions relative to the isocyanate functions is equal to 3. After immersion for 72 hours, the wood was dehydrated in a ventilated oven at 100° C. for 16 hours and heat-treated at 150° C. for 30 minutes in order to deprotect the isocyanate functions. The characteristics of the samples obtained are summarized in Table 7.

TABLE 7
Characteristics of the impregnated wood samples

| | (f) | (g) |
|---|---|---|
| Sample | T(° C.) | FW_{PU}(%) |
| G | 22 | 77 |
| H | 50 | 76 |

(f) impregnation temperature in ° C.
(g) weight fraction of polyurethane

The low loss of mass measured after Soxhlet extraction confirms the grafting efficiency and the formation of an interpenetrated network (Table 8). As regards the dimensional stability, it is higher (reaching a value of greater than 50%) in the case of impregnation at 50° C. for similar mass per unit volume values.

Moreover, the mechanical properties were determined under compression, and remain identical to the properties of non-impregnated natural wood.

TABLE 8
Dimensional stability, Soxhlet extraction
tests and mass per unit volume

| | (a) | (b) | (c) | (d) | (e) |
|---|---|---|---|---|---|
| Sample | Test | ASE₁(%) | ASE₂(%) | Δm(%) | ρ(g · cm⁻³) |
| G | humidity | 19 ± 1 | 27 ± 4 | 24 | 0.6 |
| | immersion | 42 ± 3 | 36 ± 2 | | |
| H | humidity | 32 ± 3 | 25 ± 1 | 26 | 0.6 |
| | immersion | 57 ± 4 | 34 ± 1 | | |

### Example 9

### Use of Baydur® as Protected Polyisocyanate

A sample J of poplar (Populus spp.) of 60×60×10 mm³ (radial×tangential×longitudinal) was simultaneously impregnated with PEG 400 and with a protected triisocyanurate sold by Bayer S. A. under the trade name Bayhydur® VP LS 2310, the formula of which is identical to that of Rhodocoat®. To do this, this sample was immersed in an aqueous solution of PEG 400 in which the triisocyanurate was dispersed at room temperature. The amounts of reagents were adjusted such that the molar ratio of the hydroxyl functions relative to the isocyanate functions is equal to 3. After immersion for 72 hours, the wood was dehydrated in a ventilated oven at 100° C. for 16 hours and heat-treated at 150° C. for 30 minutes in order to deprotect the isocyanate functions. A polyurethane coat (vitrifying varnish) was then applied to the surface of the sample. The weight fraction of polyurethane obtained was 59.3%.

As might be expected by a person skilled in the art, it is found that the surface application of the polyurethane coat increases the dimensional stability of the wood (see Table 9). The ASE values reach more than 60% after conditioning in a humid atmosphere, similarly to the previous samples, the mass per unit volume remaining substantially less than unity (in g.cm⁻³).

TABLE 9
Dimensional stability

| | (a) | (b) | (c) |
|---|---|---|---|
| Sample | Test | ASE₁(%) | ASE₂(%) |
| J | humidity | 64 ± 12 | 63 ± 10 |
| | immersion | 49 ± 2 | 42 ± 1 |

As demonstrated by Examples 8 and 9, protected polyisocyanates other than carbonylbis(caprolactam) (CBC) may be used in the impregnation composition according to the wood treatment method of the invention, even though the two protected polyisocyanates tested herein, Baydur® and Rhodocoat®, give poorer results than carbonylbis(caprolactam).

In summary, the treatment method according to the present invention has numerous advantages over the prior art.

A first definite advantage of the method according to the present invention is the saving in time that it allows in making a polyurethane network and thus stabilizing the wood. This saving in time is at least partly due to the fact that only one bath is used to impregnate the wood, this bath comprising an aqueous impregnation composition containing both the polyol and the polyisocyanate. Another very important advantage of the treatment method according to the invention is that it may be applied directly to a green or water-saturated wood. Indeed, in contrast with the isocyanate-based methods of the prior art, it is not necessary herein to dehydrate the wood beforehand, which represents a saving in time and moreover avoids the risks of cracking of the wood that are associated with dehydration.

Furthermore, besides the saving in time that it allows, the fact that this method can be applied to a “end-grained” wooden element makes it possible to re-enhance the value of species of tree that are undervalued as a result of their mediocre mechanical properties (i.e. poplar, Scotch pine, etc.), these being species which, on account of their low density, are intrinsically readily impregnable.

In addition, the implementation of the method according to the invention may be performed under improved working conditions, especially compared with the method described in Belgian patent BE 799 494, which produces toxic vapours, whether in terms of safety for the personnel or in terms of environmental friendliness. This is explained by the fact that the impregnation is performed in aqueous phase, and that the reaction products subsequently formed during the formation of the polyurethane network are not toxic, either to man or to the environment.

Moreover, in contrast with the two-step impregnation involving the vaporization of polyisocyanate, the observations by scanning electron microscopy of cross sections of wood impregnated by means of the method according to the present invention demonstrate a homogeneous profile of impregnation and crosslinking throughout the height/depth of the sample.

1. A method for treating a wooden element, in particular made of “end-grained” wood, comprising the following steps:
impregnating by immersion of said wooden element in an impregnation bath containing an aqueous impregnation composition comprising at least a first constituent comprising a polyol and at least a second constituent comprising a carbonylbis(caprolactam) (CBC) capable of reacting under certain conditions with the said first constituent to form a polyurethane, the second constituent being unreactive towards the said first constituent and inert towards water in this impregnation step;
removing from the impregnation bath and dehydrating said wooden element;
forming a polyurethane network within the wooden element thus impregnated during a heat treatment by reacting said first constituent with said second constituent by means of a rise in temperature.

2. The method according to claim 1, wherein the wood of the wooden element is in green or water-saturated form.

3. The method according to claim 1, wherein the first constituent of the impregnation composition is a water-soluble polyol comprising one or more active hydrogens and selected from the group consisting of mono-ol and polyol polyethers, mono-ol and polyol polyacrylics, mono-ol and polyol polyvinyls, polysaccharides, derivatives thereof in which at least one hydroxyl function is substituted with a thiol or amine function, and mixtures and copolymers thereof.

4. The method of claim 1, wherein the first constituent of the impregnation composition is an oligomer with a molecular weight of between 100 and 5000

5. (canceled)

6. (canceled)

7. The method of claim 1, wherein each of the first and second constituents is present in the aqueous impregnation composition in a concentration of between 10⁻³ and 5 mol/l.

8. The method of claim 1, wherein the impregnation step is performed at a temperature of between 0° C. and 100° C.

9. The method of claim 8, wherein the impregnation step is performed at room temperature.

10. The method of claim 1, wherein the duration of impregnation step is between 10 minutes and 72 hours.

11. The method of claim 1, wherein the impregnation step is performed at a pressure generally of between 10⁻³ and 10² bar.

12. The method of claim 11, wherein the impregnation step is performed at atmospheric pressure.

13. The method of claim 1, wherein the heat treatment is performed at a temperature of between 50° C. and 250° C., and the duration of which is predetermined.

14. The method of claim 1, wherein the duration of the heat treatment is between 5 minutes and 5 hours.

15. The method of claim 1, wherein the heat treatment is performed at a pressure of between 10⁻³ and 10² bar.

16. The method of claim 1, wherein the dehydration of the wooden element is performed by heating or by depressurization.

17. A wooden element obtained by the method of claim 1.

18. Impregnation bath or impregnation composition for performing the method of claim 1, wherein said impregnation composition is an aqueous solution comprising a first constituent comprising a polyol and at least a second constituent comprising a polyisocyanate whose isocyanate functions are protected so as to render said polyisocyanate inert towards water and towards the alcohol function(s) of said first constituent at room temperature, said isocyanate functions being capable, under particular conditions of use, of being deprotected and thus of reacting with the alcohol function(s) of said first constituent to form a polyurethane.

19. (canceled)

20. (canceled)

21. The method of claim 4, wherein the first constituent of the impregnation composition is an oligomer with a molecular weight of between 200 and 1000.

22. The method of claim 7, wherein each of the first and second constituents is present in the aqueous impregnation composition in a concentration of between 0.1 and 1 mol/l.

23. The method of claim 8, wherein the impregnation step is performed at a temperature of between 20° C. and 60° C.

24. The method of claim 10, wherein the duration of impregnation step is between 1 and 24 hours.

25. The method of claim 11, wherein the impregnation step is performed at a pressure of between 0.1 and 10 bar.

26. The method of claim 14, wherein the duration of the heat treatment is between 15 minutes and 120 minutes.

27. The method of claim 15, wherein the heat treatment is performed at a pressure of between 0.1 and 10 bar.
